(19) United States
(12) Patent Application Publication
(10) Pub. No.: US 2024/0268270 A1
(43) Pub. Date: Aug. 15, 2024

(54) Combine

(71) Applicant: Kubota Corporation, Osaka-shi (JP)

(72) Inventors: Takafumi Mitsui, Sakai-shi (JP); Toshinari Nishimura, Sakai-shi (JP)

(21) Appl. No.: 18/566,780

(22) PCT Filed: Jun. 7, 2022
(86) PCT No.: PCT/JP2022/022974

§ 371 Date: Dec. 4, 2023

(30) Foreign Application Priority Data
Jun. 9, 2021 (JP) 2021-096680

(51) Int. Cl. A01F 12/18

(52) U.S. Cl. CPC A01F 12/18

(57) ABSTRACT

In a combine, each of a plurality of dust-sending valves 30B includes a first dust-sending member 31 provided in an upper portion of a threshing chamber 16 in a state of extending in a left-right direction of a threshing chamber and in a state in which a sending angle is changeable by swinging, and a second dust-sending member 32 provided in a state of being fixed to a position located on an upstream side in a rotation direction of a threshing cylinder with respect to the first dust-sending member 31 such that a sending angle is not changeable. A portion of a top plate 19 facing the second dust-sending member 32 has an arc shape as viewed in a direction along a rotation axis P of a threshing cylinder 20.

### CROSS-REFERENCE TO RELATED APPLICATIONS

This application is the United States national phase of International Application No. PCT/JP2022/022974 filed Jun. 7, 2022, and claims priority to Japanese Patent Application No. 2021-096680 filed Jun. 9, 2021, the disclosures of which are hereby incorporated by reference in their entireties.

### BACKGROUND OF THE INVENTION

### Field of the Invention

The present invention relates to a combine.

### Description of Related Art

Some combines include a reaping section that reaps planted crops in a field and a threshing device that threshes the crops from the reaping section. In this type of combine, the threshing device includes a threshing chamber to be fed with the crops from the reaping section, a threshing cylinder rotatably provided in the threshing chamber and configured to thresh the crops fed into the threshing chamber, a top plate covering the threshing chamber from above, and a plurality of dust-sending valves provided on an inner side of the top plate in a state of being arranged in a direction along a rotation axis of the threshing cylinder and configured to send and guide a threshing target toward a rear of the threshing chamber. Each of the plurality of dust-sending valves includes a first dust-sending member provided in an upper portion of the threshing chamber in a state of extending in a left-right direction of the threshing chamber and in a state in which a sending angle is changeable by swinging, and a second dust-sending member provided in the upper portion of the threshing chamber in a state of being fixed to a position located on an upstream side in a rotation direction of the threshing cylinder with respect to the first dust-sending member such that a sending angle is not changeable. In this type of combine, even when reaped crops are different, the threshing target in the threshing chamber is transferred toward the rear of the threshing chamber by sending and guiding which is performed by the first dust-sending member at a sending angle corresponding to the type of the crops and sending and guiding which is performed by the second dust-sending member, and the threshing target can be threshed while moving through the threshing chamber at a movement speed corresponding to a quality thereof.

As this type of combine, there is a combine disclosed in JP2013-63022A. The combine disclosed in JP2013-63022A includes a first dust-sending member (movable dust-sending valve) and a second dust-sending member (fixed dust-sending valve).

### SUMMARY OF THE INVENTION

Even in the combine including the first dust-sending member and second dust-sending member, when a threshing target, which is applied with a turning force by the threshing cylinder and flows in the rotation direction of the threshing cylinder at the upper portion of the threshing chamber, comes into contact with the top plate and receives a strong flow resistance, it becomes difficult for the threshing target to flow toward the rear of the threshing chamber. Further, when the threshing target is subjected to the strong flow resistance by the top plate, contact with the first dust-sending member and the second dust-sending member becomes weak, the sending and guiding by the first dust-sending member and the second dust-sending member is not efficiently performed, and the threshing target does not move through the threshing chamber at a movement speed suitable for the quality thereof, making it not possible to perform appropriate threshing processing without excess or deficiency. In particular, if a large amount of reaped crops is supplied to the threshing chamber, the movement speed of the threshing target in the threshing chamber tends to be inappropriate, and thus a reaping speed cannot be set too high, so that not too much reaped crops are supplied to the threshing chamber.

The present invention provides a combine in which the threshing target can be moved through the threshing chamber at an appropriate movement speed regardless of a change in a type of the reaped crops, allowing threshing processing to be performed appropriately while reaping.

A combine according to the present invention includes: a reaping section that reaps a planted crop in a field; and a threshing device that threshes a crop from the reaping section. The threshing device includes a threshing chamber to be fed with a crop from the reaping section, a threshing cylinder rotatably provided in the threshing chamber and configured to thresh the crop fed into the threshing chamber, a top plate covering the threshing chamber from above, and a plurality of dust-sending valves provided on an inner side of the top plate in a state of being arranged in a direction along a rotation axis of the threshing cylinder and configured to send and guide a threshing target toward a rear of the threshing chamber. Each of the plurality of dust-sending valves includes a first dust-sending member provided in an upper portion of the threshing chamber in a state of extending in a left-right direction of the threshing chamber and in a state in which a sending angle is changeable by swinging, and a second dust-sending member provided in the upper portion of the threshing chamber in a state of being fixed to a position located on an upstream side in a rotation direction of the threshing cylinder with respect to the first dust-sending member such that a sending angle is not changeable. A portion of the top plate facing the second dust-sending member has an arc shape as viewed in a direction along the rotation axis.

According to this configuration, the sending angle of the first dust-sending member is appropriately changed in accordance with a quality of the reaped crop. Thus, even when the threshing target applied with a turning force by the threshing cylinder and flowing upward in the threshing chamber comes into contact with a portion of the top plate facing the second dust-sending member, the threshing target flows smoothly without being subjected to too strong flow resistance due to the arc shape of this portion, comes into contact with the second dust-sending member with force, and is appropriately sent and guided by the second dust-sending member. Further, the threshing target comes into contact with the first dust-sending member with force, is appropriately sent and guided by the sending angle suitable for a quality of the crops of the first dust-sending member, and is threshed while moving toward the rear of the threshing chamber at an appropriate movement speed corresponding to the quality of the objects to be threshed. Therefore, it is possible to perform reaping while performing appropriate threshing processing without excess or deficiency regardless of a change in the quality of the reaped crops.

In the present invention, it is preferable that the first dust-sending member has a notch formed in a lower corner of the first dust-sending member on the upstream side in the rotation direction of the threshing cylinder, and as viewed in the direction along the rotation axis, an end portion of the second dust-sending member on a downstream side in the rotation direction of the threshing cylinder enters the notch.

According to this configuration, even when a position of the end portion of the first dust-sending member on the upstream side in the rotation direction of the threshing cylinder and a position of the end portion of the second dust-sending member on the downstream side in the rotation direction of the threshing cylinder are displaced in a front-rear direction of the threshing chamber by a change in the sending angle of the first dust-sending member, the end portion of the first dust-sending member faces the end portion of the second dust-sending member by the notch, and thus the objects to be threshed that are sent and guided toward the downstream side in the rotation direction of the threshing cylinder by the second dust-sending member are unlikely to be caught by the end portion of the first dust-sending member, and the objects to be threshed can be smoothly moved toward the rear of the threshing chamber.

In the present invention, it is preferable that a side portion of the top plate on a downstream side in the rotation direction of the threshing cylinder is formed in a state of inclining downward and outward to a lateral side of the threshing chamber, and the first dust-sending member includes a downstream side dust-sending section extending along the side portion at a position on the downstream side in the rotation direction of the threshing cylinder.

According to this configuration, even when the objects to be threshed flow along the side portion of the top plate, the sending and guiding is performed by the downstream side dust-sending section of the first dust-sending member, so that the objects to be threshed can be accurately sent and guided by the first dust-sending member.

In the present invention, it is preferable that a gap is provided between the side portion and an upper edge portion of the downstream side dust-sending section.

According to this configuration, relative movement between the downstream side dust-sending section and the side portion of the top plate is enabled so that the first dust-sending member can swing. Therefore, even when the objects to be threshed enter between the downstream side dust-sending section and the side portion, the objects to be threshed easily come out of a space between the downstream side dust-sending section and the side portion due to the presence of the gap, and thus it is easy to prevent the objects to be threshed from clogging.

In the present invention, it is preferable that the first dust-sending member has a support shaft provided at a position located on the downstream side in the rotation direction of the threshing cylinder with respect to a center in a left-right direction of the threshing chamber and on the upstream side in the rotation direction of the threshing cylinder with respect to the downstream side dust-sending section, and the first dust-sending member is supported in a swingable state with the support shaft as a swing pivot.

According to this configuration, compared to a configuration in which the support shaft of the first dust-sending member is provided at a position on the upstream side in the rotation direction of the threshing cylinder with respect to the center in the left-right direction of the threshing chamber, the sending angle of the first dust-sending member can be changed over a wide angle range while narrowing the gap between the downstream side dust-sending section and the side portion of the top plate part, and compared to a configuration in which the support shaft is provided in the downstream side dust-sending section, the sending angle of the first dust-sending member can be changed over a wide angle range while reducing a step provided between the first dust-sending member and the second dust-sending member in the front-rear direction of the threshing chamber. Therefore, the objects to be threshed can be sent and guided over a wide angle range by the first dust-sending member while smoothly flowing from the second dust-sending member to the first dust-sending member.

In the present invention, it is preferable that a protrusion length by which an end portion of the first dust-sending member on the upstream side in the rotation direction of the threshing cylinder protrudes from the top plate toward the threshing cylinder is the same as a protrusion length by which an end portion of the second dust-sending member on a downstream side in the rotation direction of the threshing cylinder protrudes from the top plate toward the threshing cylinder.

According to this configuration, since there is no step in a radial direction of the threshing cylinder between the end portion of the first dust-sending member on the upstream side in the rotation direction of the threshing cylinder and the end portion of the second dust-sending member on the downstream side in the rotation direction of the threshing cylinder, the objects to be threshed can smoothly flow from the second dust-sending member to the first dust-sending member and is hardly caught by the first dust-sending member.

### BRIEF DESCRIPTION OF THE DRAWINGS

FIG. 1 is a left side view showing an entire combine.

FIG. 2 is a sectional view showing a second threshing processing section.

FIG. 3 is a sectional view taken along line III-III in FIG. 2.

FIG. 4 is a plan view showing a dust-sending valve.

### DESCRIPTION OF THE INVENTION

Hereinafter, an embodiment which is an example of the present invention will be described with reference to the drawings.

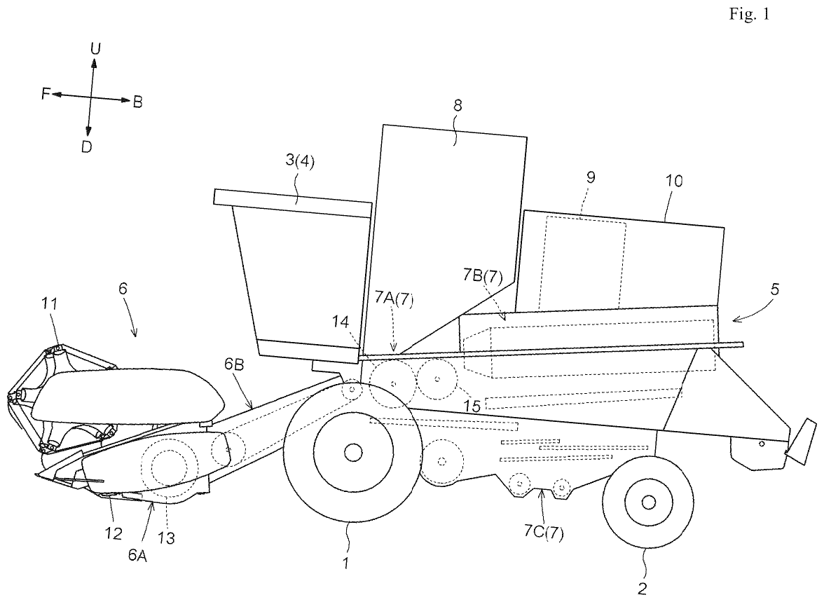

In the following description, regarding a traveling machine body of a combine, a direction of an arrow F shown in FIG. 1 is referred to as “machine body front side”, a direction of an arrow B is referred to as “machine body rear side”, a direction of an arrow U is referred to as “machine body upper side”, a direction of an arrow D is referred to as “machine body lower side”, a direction of a front side of a paper surface is referred to as “machine body left side”, and a direction of a back side of the paper surface is referred to as “machine body right side”.

### (Overall Configuration of Combine)

As shown in FIG. 1, a combine includes a traveling machine body 5 that is supported by a pair of left and right front wheels 1 and a pair of left and right rear wheels 2, and has a driving section 4 whose riding space is covered by a cabin 3. A reaping and conveying section 6 is provided in front of the traveling machine body 5 to reap planted crops such as rice and wheat in a field and convey the reaped crops to the rear side. A threshing device 7 that receives and threshes the reaped crops from the reaping and conveying section 6 and sorts objects to be threshed, a grain tank 8 that collects and stores grains obtained by the threshing device 7, and an engine section 10 that has an engine 9 as a power source are provided behind the driving section 4 of the traveling machine body 5. The grain tank 8 is provided above a front portion of the threshing device 7, and the engine section 10 is provided above a rear portion of the threshing device 7.

The reaping and conveying section 6 includes a reaping section 6A that is provided at a front portion of the reaping and conveying section 6, reaps crops planted in a field, and gathers the reaped crops in a center portion in a reaping width direction, and a feeder 6B provided as a crop conveying section that extends rearward from a rear portion of the reaping section 6A and conveys the reaped crops from the reaping section 6A toward the threshing device 7 at the machine body rear side. The reaping section 6A includes a rotation reel 11 that rakes tips of the planted crops to be reaped rearward, a reaping blade 12 that reaps the planted crops by cutting bases of the planted crops, and a lateral sending auger 13 that conveys the reaped crops in the reaping width direction and gathers the reaped crops in front of the feeder 6B.

### (Configuration of Threshing Device)

As shown in FIG. 1, the threshing device 7 includes a first threshing processing section 7A that is provided on an upper portion of the threshing device 7 and threshes the reaped crops from the feeder 6B, a second threshing processing section 7B that is provided behind the first threshing processing section 7A and threshes threshed objects processed in the first threshing processing section 7A, and a sorting section 7C that is provided at a lower portion of the threshing device 7 and sorts the threshed objects from the first threshing processing section 7A and the second threshing processing section 7B.

### (Configuration of First Threshing Processing Section)

In the first threshing processing section 7A, a width of the first threshing processing section 7A in a left-right direction of the traveling machine body is approximately the same as a width of the feeder 6B in the left-right direction of the traveling machine body, and is larger than a width of the second threshing processing section 7B in the left-right direction of the traveling machine body.

The first threshing processing section 7A is provided with a threshing section having a first threshing cylinder 14 that can be driven to rotate about an axis extending in the left-right direction of the traveling machine body, and an intermediate conveyance body 15 provided behind the first threshing cylinder 14. The intermediate conveyance body 15 is driven to rotate about the axis extending in the left-right direction of the traveling machine body. A width of the intermediate conveyance body 15 in the left-right direction of the traveling machine body is the same as the width of the first threshing processing section 7A in the left-right direction of the traveling machine body.

In the first threshing processing section 7A, the entire reaped crops are fed by the feeder 6B to the threshing section having the first threshing cylinder 14 and threshed by the first threshing cylinder 14, and the threshed objects are raked by the intermediate conveyance body 15 to the second threshing processing section 7B.

### (Configuration of Second Threshing Processing Section)

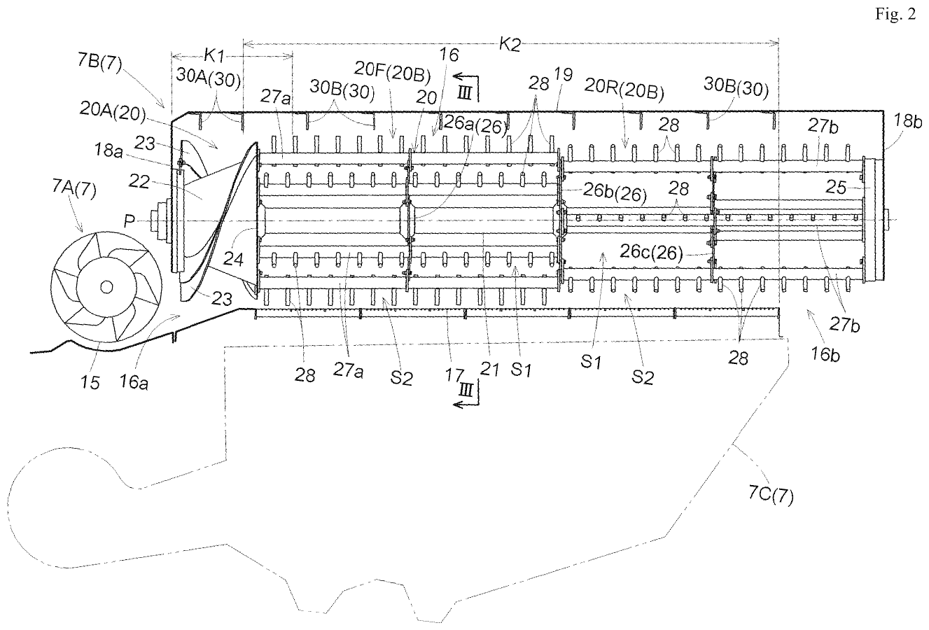

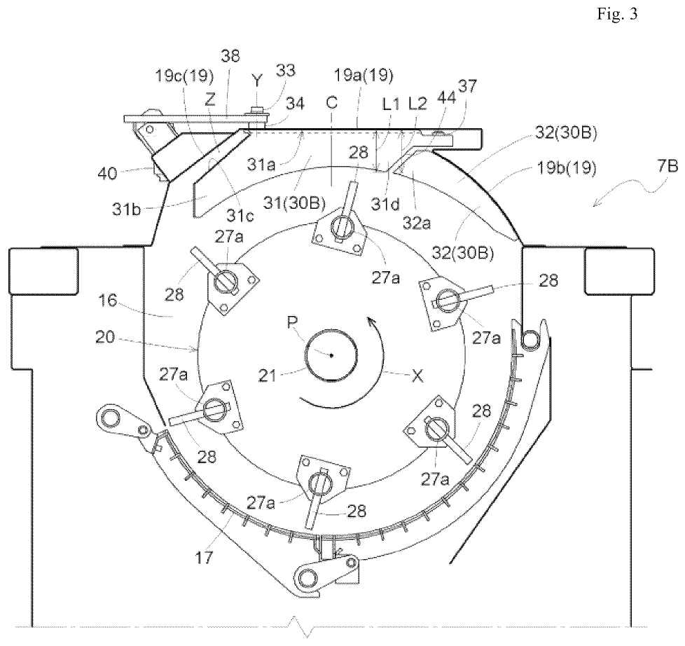

As shown in FIGS. 2 and 3, the second threshing processing section 7B includes a threshing chamber 16 located on the upper portion of the threshing device 7, a threshing cylinder 20 having a front-rear threshing cylinder support shaft 21 that is located along a conveyance direction of the reaped crops in the threshing chamber 16 and rotating around the threshing cylinder support shaft 21 as a pivot, and an arc-shaped receiving net 17 located below the threshing cylinder 20.

The threshing chamber 16 is defined and formed by a front wall 18a and a rear wall 18b that support the threshing cylinder support shaft 21, the receiving net 17, and a top plate 19 that covers the threshing chamber 16 from above. A supply port 16a is formed in a front lower portion of the threshing chamber 16, through which the threshed objects from the first threshing processing section 7A can be fed into the threshing chamber 16. A culm discharge portion 16b is formed at a rear lower portion of the threshing chamber 16, from which threshed culms can be discharged.

As shown in FIG. 2, in an upper portion of the threshing chamber 16, a plurality of dust-sending valves 30 that are arranged so as to be spaced in a direction along a rotation axis P of the threshing cylinder 20 are provided on an inner side of the top plate 19. The objects to be threshed transferred to the upper portion of the threshing chamber 16 by rotation of the threshing cylinder 20 come into contact with the dust-sending valves 30 and are sent and guided by the dust-sending valves 30, and thus the threshing cylinder 20 sends and guides the objects to be threshed toward the rear of the threshing chamber 16.

The threshing cylinder support shaft 21 is rotatably supported by the front wall 18a and the rear wall 18b in an inclined posture with the rear raised. The threshing cylinder 20 is rotationally driven in a rotation direction indicated by an arrow X in FIG. 3 (a counterclockwise direction when the threshing cylinder 20 is viewed from the rear) around an axis (rotation axis P) of the threshing cylinder support shaft 21 by power from the engine 9, thereby threshing the objects to be threshed fed into the threshing chamber 16. The threshing cylinder 20 applies a turning force to the objects to be threshed, and the objects to be threshed to which the turning force is applied come into contact with the dust-sending valves 30 and are sent and guided by the dust-sending valves 30, so that the threshing cylinder 20 threshes the objects to be threshed while transferring the objects to be threshed toward the rear of the threshing chamber 16.

The receiving net 17 is a concave receiving net formed in a lattice shape, receives the objects to be threshed supplied to the threshing chamber 16, assists the threshing processing of the threshing cylinder 20 performed on the objects to be threshed, and allows single grains, grains with stalks, etc. obtained in the threshing process, or straw waste generated in the threshing processing to leak down toward the lower sorting section 7C while preventing the threshed grain culms (waste culms) from leaking into the sorting section 7C.

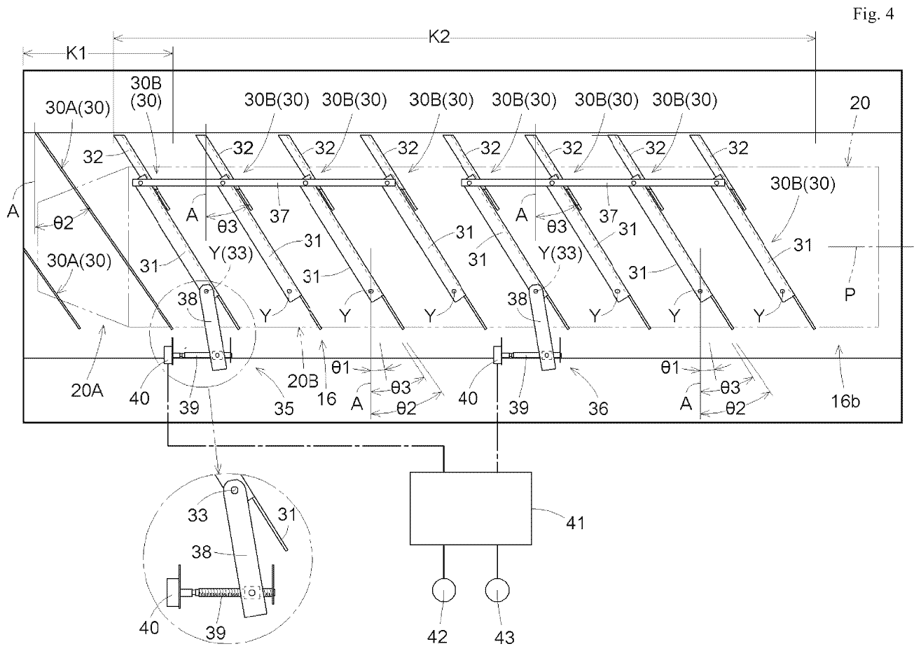

As shown in FIGS. 2 and 4, the threshing cylinder 20 includes a raking section 20A provided in a front portion of the threshing cylinder 20 and a threshing section 20B connected to a rear portion of the raking section 20A.

### (Configuration of Raking Section)

As shown in FIG. 2, the raking section 20A includes a base section 22 whose diameter decreases toward a front end side of the threshing cylinder 20, and helical vanes 23 provided around an outer circumferential portion of the base section 22 in a state of rising toward the outside of the base section 22 from the outer circumferential portion of the base section 22. Two helical vanes 23 are provided. These two helical vanes 23 are provided extending from a rear end portion to a front end portion of the base section 22 in the form of double helices arranged so as to be spaced in the circumferential direction of the base section 22.

The base section 22 is made of a sheet metal member rolled into a shape of a truncated cone. The base section 22 is supported by the threshing cylinder support shaft 21 via a circular plate member (not shown) that couples the front end portion of the base section 22 and the threshing cylinder support shaft 21 and a front support member 24 that couples the rear end portion of the base section 22 and the threshing cylinder support shaft 21.

In the raking section 20A, the base section 22 is driven by the threshing cylinder support shaft 21 via the circular plate member and the front support member 24, and the two helical vanes 23 are rotationally driven with the rotation axis P of the threshing cylinder 20 as a rotation center. The objects to be threshed fed by the intermediate conveyance body 15 from the supply port 16a to the threshing chamber 16 are raked toward the rear of the threshing chamber 16 by the rotating helical vanes 23.

### Configuration of Threshing Section

As shown in FIG. 2, the threshing section 20B includes the front support member 24 supported by a portion of the threshing cylinder support shaft 21 corresponding to the rear portion of the raking section 20A, a rear support member 25 supported by a portion of the threshing cylinder support shaft 21 on the rear side of the front support member 24, and three intermediate support members 26 supported by a portion of the threshing cylinder support shaft 21 between the front support member 24 and the rear support member 25. The three intermediate support members 26 are arranged at equal intervals in a front-rear direction of the threshing cylinder support shaft 21. Hereinafter, among the three intermediate support members 26, the frontmost intermediate support member 26 is referred to as a first intermediate support member 26a, the middle intermediate support member 26 is referred to as a second intermediate support member 26b, and the rearmost intermediate support member 26 will be referred to as a third intermediate support member 26c.

As shown in FIG. 2, the threshing section 20B includes a front threshing section 20F having six rod-shaped front divided threshing teeth support members 27a located on the front side of the second intermediate support member 26b, and a rear threshing section 20R having six rod-shaped rear divided threshing teeth support members 27b located on the rear side of the second intermediate support member 26b. The front divided threshing teeth support member 27a and the rear divided threshing teeth support member 27b are obtained by dividing a single threshing teeth support member having a front-rear length spanning between the front divided threshing teeth support member 27a and the rear divided threshing teeth support member 27b into two in the front-rear direction at a position corresponding to the second intermediate support member 26b. A position of the front divided threshing teeth support member 27a and a position of the rear divided threshing teeth support member 27b are displaced in the circumferential direction of the threshing cylinder 20.

As shown in FIG. 2, the front threshing section 20F includes six front divided threshing teeth support members 27a that are supported by the threshing cylinder support shaft 21 in a state along the threshing cylinder support shaft 21 and at intervals in the circumferential direction of the threshing cylinder 20. The six front divided threshing teeth support members 27a are supported by the threshing cylinder support shaft 21 via the front support member 24, the first intermediate support member 26a, and the second intermediate support member 26b. The six front divided threshing teeth support members 27a are supported by the threshing cylinder support shaft 21 in a state in which the arrangement pitch of the six front divided threshing teeth support members 27a is the same in the circumferential direction of the threshing cylinder 20. A plurality of threshing teeth 28 are supported by each of the six front divided threshing teeth support members 27a in a state in which the threshing teeth 28 are spaced in a direction along the threshing cylinder support shaft 21. The threshing teeth 28 of each of the front divided threshing teeth support members 27a protrude outward in a radial direction of the threshing cylinder 20 from the front divided threshing teeth support member 27a.

As shown in FIG. 2, the rear threshing section 20R includes six rear divided threshing teeth support members 27b that are supported by the threshing cylinder support shaft 21 in a state along the threshing cylinder support shaft 21 and at intervals in the circumferential direction of the threshing cylinder 20. The six rear divided threshing teeth support members 27b are supported by the threshing cylinder support shaft 21 via the second intermediate support member 26b, the third intermediate support member 26c, and the rear support member 25. The six rear divided threshing teeth support members 27b are supported by the threshing cylinder support shaft 21 in a state in which the arrangement pitch of the six rear divided threshing teeth support members 27b is the same in the circumferential direction of the threshing cylinder 20. A plurality of threshing teeth 28 are supported by each of the six rear divided threshing teeth support members 27b in a state in which the threshing teeth 28 are spaced in a direction along the threshing cylinder support shaft 21. The threshing teeth 28 of each of the rear divided threshing teeth support member 27b protrude outward in the radial direction of the threshing cylinder 20 from the rear divided threshing teeth support member 27b.

In the present embodiment, six front divided threshing teeth support member 27a and six rear divided threshing teeth support member 27b are provided. Alternatively, five or less, or seven or more front divided threshing teeth support member 27a, and five or less, or seven or more rear divided threshing teeth support member 27b may be provided. In the present embodiment, the front divided threshing teeth support member 27a and the rear divided threshing teeth support member 27b are each formed by a round pipe steel member. In addition to a round pipe steel member, a variety of members such as a round steel member, a square bar steel member, and a square pipe steel member may be used for the front divided threshing teeth support member 27a and the rear divided threshing teeth support member 27b. An angled member or a channel member may also be used for the front divided threshing teeth support member 27a and the rear divided threshing teeth support member 27b. In the present embodiment, the threshing teeth are each formed by a round steel member. In addition to a round steel member, a variety of members such as a square bar steel member, a round pipe member, and various pipe members may be used for the threshing teeth 28.

In the second threshing processing section 7B, the objects to be threshed fed to the threshing chamber 16 by the intermediate conveyance body 15 via the supply port 16a are raked toward the rear of the threshing chamber 16 by the helical vanes 23 of the raking section 20A and then threshed by the threshing section 20B and the receiving net 17. The grains obtained by the threshing processing are leaked down from the receiving net 17 to be supplied to the sorting section 7C, and threshed grain culms and cut straws are discharged from the culm discharge portion 16b to the outside of the threshing chamber 16.

The threshing cylinder 20 is formed in a shape of a cage in which an internal space S1 (see FIG. 2) in communication with the threshing chamber 16 via spaces between the front divided threshing teeth support members 27a and spaces between the rear divided threshing teeth support members 27b is formed, and includes a plurality of threshing teeth 28 arranged to be spaced in the circumferential direction of the threshing cylinder 20 and a processing direction. The threshing teeth 28 protrude outward in the radial direction of the threshing cylinder from an outer circumferential surface of the threshing cylinder 20 which is formed by the front divided threshing teeth support members 27a and the rear divided threshing teeth support members 27b.

Accordingly, the threshing cylinder 20 introduces the objects to be threshed from the raking section 20A into the space between the threshing section 20B and the receiving net 17 by rotating with the threshing cylinder support shaft 21 as the rotation center in the processing direction. The threshing cylinder 20 threshes the objects to be thresh located in a threshing space S2 (see FIG. 2) between the outer circumferential surface of the threshing cylinder and the receiving net 17, for example, by hitting with the front divided threshing teeth support members 27a, the rear divided threshing teeth support members 27b, and the threshing teeth 28 and combing with the threshing teeth 28, and allows entry of processed objects resulting from the threshing processing into the internal space S1. While stirring the processed objects from the threshing space S2 and the processed objects in the internal space S1, the threshing cylinder 20 threshes these processed objects, for example, by hitting with the front divided threshing teeth support member 27a and the rear divided threshing teeth support members 27b, and the threshing teeth 28 and combing with the threshing teeth 28.

### (Configuration of Dust-Sending Valve)

As shown in FIGS. 2 and 4, in the upper portion of the threshing chamber 16, the plurality of dust-sending valves 30 arranged in the direction along the rotation axis P of the threshing cylinder 20 are provided on the inner side of the top plate 19. In the present embodiment, ten dust-sending valves 30 are provided. Alternatively, nine or less or eleven or more dust-sending valves 30 may be provided.

As shown in FIGS. 2 and 4, the frontmost dust-sending valve 30A and the dust-sending valve 30A adjacent to the frontmost dust-sending valve 30A among the ten dust-sending valves 30 are provided above a portion K1 of the threshing chamber 16 where the raking section 20A of the threshing cylinder 20 is located. The two dust-sending valves of the frontmost dust-sending valve 30A and the dust-sending valve 30A adjacent to the frontmost dust-sending valve 30A are dust-sending valves for raking that send and guide reaped grain culms to be subjected to raking processing by the raking section 20A toward the rear of the threshing chamber 16.

As shown in FIGS. 2 and 4, eight dust-sending valves 30B excluding the two dust-sending valves 30A for raking among the ten dust-sending valves 30 are provided above a portion K2 of the threshing chamber 16 where the threshing section 20B of the threshing cylinder 20 is located. A rear end portion of the portion K2 of the threshing chamber 16 faces a front portion of the culm discharge portion 16b. The eight dust-sending valves 30B are dust-sending valves for threshing processing that send and guide the objects to be subjected to the threshing processing by the threshing section 20B toward the rear of the threshing chamber 16. In the present embodiment, eight dust-sending valves 30B for threshing processing are provided. Alternatively, seven or less or nine or more dust-sending valves 30B for threshing processing may be provided.

### (Configuration of Dust-Sending Valve for Raking)

As shown in FIG. 4, each of the two dust-sending valves 30A for raking is provided on the inner side of the top plate 19 in a state of being fixed such that a sending angle θ2 cannot be changed. The two dust-sending valves 30A for raking are fixed to the top plate 19 by welding.

### (Configuration of Dust-Sending Valve for Threshing Processing)

As shown in FIGS. 3 and 4, each of the eight dust-sending valves 30B for threshing processing has a first dust-sending member 31 provided on the inner side of the top plate 19 in a state of extending in the left-right direction of the threshing chamber 16 in the upper portion of the threshing chamber 16, and a second dust-sending member 32 provided on an upstream side in the rotation direction of the threshing cylinder 20 with respect to the first dust-sending member 31 in the upper portion of the threshing chamber.

As shown in FIG. 3, a center portion 19a in the left-right direction of the threshing chamber in the top plate 19 is formed in a flat plate shape as viewed in the direction along the rotation axis P of the threshing cylinder 20. That is, a cross sectional shape of the center portion 19a is a flat plate shape as viewed in the direction along the rotation axis P. A side portion 19b of the top plate 19 on the upstream side adjacent to the center portion 19a on the upstream side of the rotation direction of the threshing cylinder is formed in an arc shape as viewed in the direction along the rotation axis P of the threshing cylinder 20. That is, a cross sectional shape of the side portion 19b on the upstream side is an arc shape as viewed in the direction along the rotation axis P. A side portion 19c of the top plate 19 on a downstream side adjacent to the center portion 19a on the downstream side of the rotation direction of the threshing cylinder is formed in a flat plate shape that is inclined downward as viewed in the direction along the rotation axis P of the threshing cylinder 20 and outward to a lateral side of the threshing chamber. That is, a cross sectional shape of the side portion 19c on the downstream side is a flat plate shape as viewed in the direction along the rotation axis P.

As shown in FIG. 3, the first dust-sending member 31 is provided on the inner side of the center portion 19a of the top plate 19. An upper edge portion 31a of the first dust-sending member 31 facing the center portion 19a is formed in a linear shape along the center portion 19a. The first dust-sending member 31 includes a downstream side dust-sending section 31b extending along the side portion 19c of the top plate 19 on the downstream side at a position on the downstream side in the rotation direction of the threshing cylinder.

As shown in FIGS. 3 and 4, a support shaft 33 of the first dust-sending member 31 is provided at a position on the downstream side in the rotation direction of the threshing cylinder with respect to a center C in the left-right direction of the threshing chamber and on the upstream side in the rotation direction of the threshing cylinder with respect to the downstream side dust-sending section 31b. A boss portion 34 that supports the support shaft 33 is provided at an end portion of the center portion 19a of the top plate 19. The first dust-sending member 31 is supported by the top plate 19 in a swingable state with an axis Y of the support shaft 33 extending in an upper-lower direction of the threshing chamber as a swing pivot. A sending angle of the first dust-sending member 31 can be changed by a swinging operation with the axis Y of the first dust-sending member 31 as the swing pivot.

As shown in FIGS. 3 and 4, each of the eight second dust-sending members 32 is fixed to the inner side of the side portion 19b of the top plate 19 on the upstream side such that a sending angle θ3 cannot be changed. The side portion 19b of the top plate 19 on the upstream side faces the second dust-sending member 32 and is formed in an arc shape as viewed in the direction along the rotation axis P of the threshing cylinder 20. The second dust-sending member 32 is fixed to the side portion 19b on the upstream side of the top plate 19. The second dust-sending member 32 is fixed to the side portion 19b by coupling a portion of the second dust-sending member 32 on the downstream side in the rotation direction of the threshing cylinder to the side portion 19b by a coupling bolt and engaging a protruding portion provided on one of the second dust-sending member 32 and the side portion 19b to a recessed portion provided in the other of the second dust-sending member 32 and the side portion 19b at a position on the upstream side in the rotation direction of the threshing cylinder with respect to the coupling bolt.

As shown in FIG. 4, a sending angle of each of the eight first dust-sending members 31 can be changed within an angle range ranging from the smallest sending angle θ1 to the largest sending angle θ2. A sending angle θ3 between the sending angle θ1 and the sending angle θ2 of the first dust-sending member 31 is the same as the sending angle θ3 of the eight second dust-sending members 32. The sending angle θ2 of the first dust-sending member 31 is the same as the sending angle θ2 of each of the two dust-sending valves 30A for raking and sending. Each line A shown in FIG. 4 is a line in a direction orthogonal to the rotation axis P, which is the threshing cylinder axis of the threshing cylinder 20 in a plan view, and serves as a reference indicating the sending angles of the first dust-sending members 31, the second dust-sending members 32, and the dust-sending valves 30A.

As shown in FIGS. 3 and 4, a first sending angle adjustment mechanism 35 is provided to interlock and swing four first dust-sending members 31 from the front to the fourth among the eight first dust-sending members 31, that is, the front four first dust-sending members 31 among the eight first dust-sending members 31, thereby adjusting sending angles of the front four first dust-sending members 31. A second sending angle adjustment mechanism 36 is provided to interlock and swing four first dust-sending members 31 excluding the front four first dust-sending members 31 among the eight first dust-sending members 31, that is, the rear four first dust-sending members 31 among the eight first dust-sending members 31, thereby adjusting sending angles of the rear four first dust-sending members 31.

As shown in FIGS. 3 and 4, the first sending angle adjustment mechanism 35 includes an interlocking link 37 that pivotally supports an end portion on a side opposite to a side where the support shaft 33 is located of each of the front four first dust-sending members 31 and interlocks and couples the front four first dust-sending members 31, and an adjustment lever 38 that is coupled to the support shaft 33 of the frontmost first dust-sending member 31 of the front four first dust-sending members 31. A screw shaft 39 is engaged with the adjustment lever 38, and an adjustment motor 40 is interlocked and coupled to the screw shaft 39. The adjustment motor 40 is implemented by an electric motor.

As shown in FIGS. 3 and 4, the second sending angle adjustment mechanism 36 has the same configuration as that of the first sending angle adjustment mechanism 35. That is, the second sending angle adjustment mechanism 36 includes the interlocking link 37 that interlocks and couples the rear four first dust-sending members 31, the adjustment lever 38 coupled to the support shaft 33 of the frontmost first dust-sending member 31 of the rear four first dust-sending members 31, the screw shaft 39 engaged with the adjustment lever 38, and the adjustment motor 40 interlocked and coupled to the screw shaft 39.

In the first sending angle adjustment mechanism 35 and the second sending angle adjustment mechanism 36, when the adjustment motor 40 is driven, the screw shaft 39 is rotated by the adjustment motor 40, the adjustment lever 38 is swung by the screw shaft 39, the support shaft 33 is rotated by the adjustment lever 38, and the frontmost first dust-sending member 31 is swung with the support shaft 33 as the swing pivot. The operation of the frontmost first dust-sending member 31 is transmitted to the other three first dust-sending members 31 by the interlocking link 37, and the other three first dust-sending members 31 are swung by the same swing angle as the frontmost first dust-sending member 31 in the same swing direction as the frontmost first dust-sending member 31 with the support shaft 33 as the swing pivot.

As shown in FIG. 4, a control device 41 is linked to the adjustment motor 40 of the first sending angle adjustment mechanism 35 and the adjustment motor 40 of the second sending angle adjustment mechanism 36, and a first adjustment switch 42 and a second adjustment switch 43 are linked to the control device 41.

When the first adjustment switch 42 is operated, the control device 41 operates the adjustment motor 40 of the first sending angle adjustment mechanism 35 based on information from the first adjustment switch 42 and a setting sending angle set in advance to swing the front four first dust-sending members 31 and adjusts the sending angle of each of the front four first dust-sending members 31.

When the second adjustment switch 43 is operated, the control device 41 operates the adjustment motor 40 of the second sending angle adjustment mechanism 36 based on information from the second adjustment switch 43 and the setting sending angle set in advance to swing the rear four first dust-sending members 31 and adjusts the sending angle of each of the rear four first dust-sending members 31.

As shown in FIG. 4, the sending angle of each of the front four first dust-sending members 31 and the rear four first dust-sending members 31 is adjusted by a power of the adjustment motor 40 within an angle range having the smallest sending angle θ1 and the largest sending angle θ2.

The sending angles of the eight first dust-sending members 31 can be adjusted to the same sending angle by appropriately operating the first adjustment switch 42 and the second adjustment switch 43. In addition, for example, the sending angle of the front four first dust-sending members 31 and the sending angle of the rear four first dust-sending members 31 can be adjusted to different sending angles.

When the quality of the reaped crops is changed, by changing the sending angle of the first dust-sending member 31 to an appropriate sending angle corresponding to the quality of the reaped crops, even when the objects to be threshed applied with a turning force by the threshing cylinder 20 and flowing upward in the threshing chamber 16 come into contact with the side portion 19b of the top plate 19 on the upstream side, the objects to be threshed flow smoothly without being subjected to too strong flow resistance due to the arc shape of the side portion 19b, come into contact with the second dust-sending member 32 with force, and are sent and guided by the second dust-sending member 32. Further, the objects to be threshed come into contact with the first dust-sending member 31 with force, are sent and guided by the sending angle suitable for the quality of the crops of the first dust-sending member 31 and transferred toward the rear of the threshing chamber 16, and are subjected to the threshing processing while moving toward the rear of the threshing chamber 16 at a movement speed suitable for the quality of the objects to be threshed.

As shown in FIG. 3, a gap Z is provided between an upper edge portion 31c of the downstream side dust-sending section 31b of the first dust-sending member 31 and the side portion 19c of the top plate 19. Even when the objects to be threshed enter between the downstream side dust-sending section 31b and the side portion 19c, the objects to be threshed easily come out of the space between the downstream side dust-sending section 31b and the side portion 19c because of the gap Z.

As shown in FIG. 3, a notch 44 is formed at a lower corner of the first dust-sending member 31 on the upstream side in the rotation direction of the threshing cylinder. As viewed in the direction along the rotation axis P of the threshing cylinder 20, an end portion 32a of the second dust-sending member 32 on the downstream side in the rotation direction of the threshing cylinder enters the notch 44. Even when a position of an end portion 31d of the first dust-sending member 31 on the upstream side in the rotation direction of the threshing cylinder and a position of an end portion 32a of the second dust-sending member 32 on the downstream side in the rotation direction of the threshing cylinder are displaced in a front-rear direction of the threshing chamber by a change in the sending angle of the first dust-sending member 31, the objects to be threshed from the second dust-sending member 32 are unlikely to be caught by the end portion 31d of the first dust-sending member 31 and smoothly move toward the first dust-sending member 31.

As shown in FIG. 3, a protrusion length L1 by which the end portion 31d of the first dust-sending member 31 on the upstream side in the rotation direction of the threshing cylinder protrudes from the top plate 19 toward the threshing cylinder 20 is made equal to a protrusion length L2 by which the end portion 32a of the second dust-sending member 32 on the downstream side in the rotation direction of the threshing cylinder protrudes from the top plate 19 toward the threshing cylinder 20. No step in the radial direction of the threshing cylinder can be provided between the second dust-sending member 32 and the first dust-sending member 31.

### ALTERNATIVE EMBODIMENTS

(1) The above-described embodiment shows an example in which the threshing cylinder 20 having a shape of a cage is used, but the present invention is not limited thereto. For example, a drum-shaped threshing cylinder, a threshing cylinder having rasp threshing teeth, and a threshing cylinder combining a drum section and a cage-shaped section may be used.

(2) The above-described embodiment shows an example in which the threshing cylinder support shaft 21 is provided in an inclined posture with the rear raised, but the threshing cylinder support shaft 21 may be supported in a horizontal position.

(3) The above-described embodiment shows an example in which the threshing teeth support member is divided into the front divided threshing teeth support member 27a and the rear divided threshing teeth support member 27b, but the threshing teeth support member may be a single undivided member.

(4) The above-described embodiment shows an example in which the first dust-sending member 31 includes the downstream side dust-sending section 31b, but the downstream side dust-sending section 31b may not be provided.

(5) The above-described embodiment shows an example in which the protrusion length L1 of the first dust-sending member 31 and the protrusion length L2 of the second dust-sending member 32 are the same, but the protrusion length L1 of the first dust-sending member 31 and protrusion length L2 of the second dust-sending member 32 may be different.

(6) The above-described embodiment shows an example in which eight first dust-sending members 31 and eight second dust-sending members 32 are provided, but the present invention is not limited thereto. For example, seven or less, or nine or more of the first dust-sending members 31 and seven or less, or nine or more of the second dust-sending members 32 may be provided.

The above-described embodiment shows an example in which the front four first dust-sending members 31 and the rear four first dust-sending members 31 can be swung and adjusted separately, but all of the first dust-sending members 31 may be interlocked and swung and adjusted. Further, the swing and adjustment of the first dust-sending member 31 may not be performed using an actuator, but may be performed manually.

### INDUSTRIAL APPLICABILITY

The present invention can be applied to a combine including, in a threshing device that threshes a crop from a reaping section, a threshing chamber, a threshing cylinder rotatably provided in the threshing chamber, a top plate covering the threshing chamber from above, and a plurality of dust-sending valve sections that are provided inside the top plate in a state of being arranged in a direction along a rotation axis of the threshing cylinder and send and guide a threshing target toward a rear of the threshing chamber.

### REFERENCE SIGNS LIST

6A reaping section
7 threshing device
16 threshing chamber
19d portion (side portion)
19c side portion
20 threshing cylinder
30B dust-sending valve
31 first dust-sending member
31b downstream side dust-sending section
31c upper edge portion
31d end portion
32 second dust-sending member
32a end portion
33 support shaft
44 notch
C center
K gap
L1 protrusion length
L2 protrusion length
P rotation axis
Z gap

1. A combine, comprising:
a reaping section configured to reap a planted crop in a field; and
a threshing device configured to thresh a crop from the reaping section, and wherein:
the threshing device comprises:
a threshing chamber to be fed with a crop from the reaping section;
a threshing cylinder rotatably provided in the threshing chamber and configured to thresh the crop fed into the threshing chamber;
a top plate covering the threshing chamber from above; and
a plurality of dust-sending valves provided on an inner side of the top plate and arranged in a direction along a rotation axis of the threshing cylinder and configured to guide a threshing target toward a rear of the threshing chamber;
each of the plurality of dust-sending valves comprises:
a first dust-sending member provided in an upper portion of the threshing chamber in a state of extending in a left-right direction of the threshing chamber and in a state wherein a sending angle is changeable by swinging; and
a second dust-sending member provided in the upper portion of the threshing chamber and fixed to a position located on an upstream side in a rotation direction of the threshing cylinder with respect to the first dust-sending member such that a sending angle is not changeable; and
a portion of the top plate facing the second dust-sending member has an arc shape as viewed in a direction along the rotation axis.

2. The combine according to claim 1, wherein:
the first dust-sending member has a notch formed in a lower corner of the first dust-sending member on the upstream side in the rotation direction of the threshing cylinder, and
as viewed in the direction along the rotation axis, an end portion of the second dust-sending member on a downstream side in the rotation direction of the threshing cylinder enters the notch.

3. The combine according to claim 1, wherein:
a side portion of the top plate on a downstream side in the rotation direction of the threshing cylinder is formed in a state of inclining downward and outward to a lateral side of the threshing chamber, and
the first dust-sending member comprises a downstream side dust-sending section extending along the side portion at a position on the downstream side in the rotation direction of the threshing cylinder.

4. The combine according to claim 3, wherein:
a gap is provided between the side portion and an upper edge portion of the downstream side dust-sending section.

5. The combine according to claim 3, wherein:
the first dust-sending member has a support shaft provided at a position located on the downstream side in the rotation direction of the threshing cylinder with respect to a center in a left-right direction of the threshing chamber and on the upstream side in the rotation direction of the threshing cylinder with respect to the downstream side dust-sending section, and the first dust-sending member is supported in a swingable state with the support shaft as a swing pivot.

6. The combine according to any one of claim 1, wherein:
a protrusion length by which an end portion of the first dust-sending member on the upstream side in the rotation direction of the threshing cylinder protrudes from the top plate toward the threshing cylinder is the same as a protrusion length by which an end portion of the second dust-sending member on a downstream side in the rotation direction of the threshing cylinder protrudes from the top plate toward the threshing cylinder.

7. The combine according to claim 4, wherein:
the first dust-sending member has a support shaft provided at a position located on the downstream side in the rotation direction of the threshing cylinder with respect to a center in a left-right direction of the threshing chamber and on the upstream side in the rotation direction of the threshing cylinder with respect to the downstream side dust-sending section, and the first dust-sending member is supported in a swingable state with the support shaft as a swing pivot.
